(19) United States
(12) Patent Application Publication
(10) Pub. No.: US 2017/0338463 A1
(43) Pub. Date: Nov. 23, 2017

(54) CYLINDRICAL NONAQUEOUS ELECTROLYTE SECONDARY BATTERY

(71) Applicant: Sanyo Electric Co., Ltd., Daito-shi, Osaka (JP)

(72) Inventors: Junichi SUGAYA, Osaka (JP); Hiroyuki FUJIMOTO, Osaka (JP)

(73) Assignee: Sanyo Electric Co., Ltd., Daito-shi, Osaka (JP)

(21) Appl. No.: 15/533,484

(22) PCT Filed: Dec. 17, 2015
(86) PCT No.: PCT/JP2015/006292

§ 371 Date: Jun. 6, 2017

(30) Foreign Application Priority Data
Dec. 25, 2014 (JP) 2014-262915

(51) Int. Cl. H01M 2/34; H01M 4/525; H01M 4/587; H01M 10/0587

(52) U.S. Cl. CPC H01M 2/345; H01M 10/0587; H01M 4/525; H01M 4/587; H01M 2200/20

(57) ABSTRACT

A cylindrical nonaqueous electrolyte secondary battery having an electrode body which includes a negative electrode having a negative electrode active material, and the negative electrode active material contains a compound containing silicon (Si); a sealing body which has a current cutoff mechanism which includes an upper valve body and a lower valve body disposed below the upper valve body to be connected to the upper valve body, and in which when the gas pressure in a space formed between the upper valve body and the lower valve body is increased, a current path is cut off; and a bottom portion of the case body has a thin portion which forms at least a portion of a ring, and the thickness t of a portion deviating from the thin portion of the bottom portion is 0.25 mm<t<0.35 mm.

### TECHNICAL FIELD

The present disclosure relates to a cylindrical nonaqueous electrolyte secondary battery.

### BACKGROUND ART

Nonaqueous electrolyte secondary batteries have a high energy density and are thus widely used as power supplies for portable devices or power generating apparatuses.

Patent Document 1 describes a cylindrical nonaqueous electrolyte secondary battery in which an opening of a battery case is closed with a sealing body and the sealing body has a current cutoff mechanism. The current cutoff mechanism cuts off a current path leading from an electrode to a terminal plate at the upper end when the pressure in a battery is increased by an abnormality such as internal short circuit or the like. Also, when the pressure in the battery is further increased, a groove of a valve body constituting the sealing body is broken to discharge the gas in the battery to the outside. Therefore, it is considered that the safety of the battery can be improved.

### CITATION LIST

### Patent Document

Patent Document 1: Japanese Published Unexamined Patent Application No. 2013-073873

### SUMMARY OF INVENTION

### Technical Problem

A carbonaceous material such as graphite, amorphous carbon, or the like is widely used as a negative electrode active material used in the cylindrical nonaqueous electrolyte secondary battery. The reason for this is that the carbonaceous material has the excellent properties of high safety, an excellent initial efficiency, and good potential flatness due to no growth of dendrite while having a discharge potential equivalent to a lithium metal and lithium alloy. Also, the carbonaceous material has the excellent property of high density. However, when a negative electrode active material composed of a carbonaceous material is used, lithium can be inserted only until a composition of LiC₆, and the limit of theoretical capacity is 372 mAh/g, thereby causing a failure to increase in battery capacity.

On the other hand, silicon alloyed with lithium or a silicon compound or silicon oxide (SiOx, 0.5≦x<1.5) has a higher energy density per mass and per volume than the carbonaceous material, and thus, for example, lithium can be inserted into silicon until a composition of Li_{4.4}Si. The theoretical capacity as a negative electrode active material is 4200 mAh/g. Therefore, an attempt is made to develop a battery having a higher capacity by using silicon or a silicon alloy or SiOx in combination with a carbonaceous material as a negative electrode active material of a cylindrical nonaqueous electrolyte secondary battery.

Silicon or a silicon compound such as SiOx or the like has a larger volume change with charging and discharging than a carbonaceous material and, for example, the expansion coefficient (volume during full charging/volume during complete discharging) of a carbonaceous material during charging is about 1.1, while that of SiO is about 2.2. Therefore, when a silicon compound such as SiOx or the like and a carbonaceous material are used as a negative electrode active material of a cylindrical nonaqueous electrolyte secondary battery, large expansion/contraction of the silicon compound occurs at each time of a charge-discharge cycle as compared with when only a carbonaceous material is used as a negative electrode active material. Thus, the coefficient of volume expansion of a negative electrode plate is increased during charging and discharging in a normal operation., This easily increases the surface pressure applied to an electrode surface or the internal pressure in a battery. Therefore, in a cylindrical nonaqueous electrolyte secondary battery, an electrolyte such as an electrolytic solution present in a positive electrode and a negative electrode or present between the positive electrode and the negative electrode may be pushed out from the insides of the positive electrode and the negative electrode or from between the positive electrode and the negative electrode, thereby degrading the characteristics of a charge-discharge cycle.

Also, when a sealing body of a battery case contains a current cutoff mechanism, malfunction of the current cutoff mechanism may occur due to an increase in internal pressure of the battery during long-term or high-temperature storage of the battery. This has the possibility of decreasing the lifetime of the battery. Patent Document 1 does not disclose a method for resolving such a failure.

An object of a cylindrical nonaqueous electrolyte secondary battery according to an aspect of the present disclosure is to attempt to improve the lifetime when a negative electrode active material contains a silicon compound.

### Solution to Problem

A cylindrical nonaqueous electrolyte secondary battery according to an aspect of the present disclosure includes a bottomed cylindrical case body which houses an electrode body, and a sealing body which seals an opening of the case body. The electrode body is formed by winding a positive electrode having a positive electrode active material and a negative electrode having a negative electrode active material with a separator interposed between the positive electrode and the negative electrode. The negative electrode active material contains a compound containing silicon (Si). The sealing body has a current cutoff mechanism which includes an upper valve body and a lower valve body disposed below the upper valve body to be connected to the upper valve body and in which a current path is formed to electrically connect the electrode body and the upper valve body through the lower valve body, and when the gas pressure in a space formed between the upper valve body and the lower valve body is increased, the upper valve body is separated from the lower valve body to cut off the current path. A bottom portion of the case body has a thin portion which forms at least a portion of a ring, and the thickness t of a portion deviating from the thin portion of the bottom portion is 0.25 mm<t<0.35 mm.

### Advantageous Effects of Invention

According to a cylindrical nonaqueous electrolyte secondary battery in an aspect of the present disclosure, when a negative electrode active material contains a silicon compound, the characteristics of a charge-discharge cycle can be improved, and malfunction of a current cutoff mechanism can be suppressed, thereby permitting an attempt to improve the lifetime.

### BRIEF DESCRIPTION OF DRAWINGS

FIG. 1 is a sectional view of a cylindrical nonaqueous electrolyte secondary battery as an example of an embodiment.

FIG. 2 is a drawing as viewed from the lower side of FIG. 1.

FIG. 3 is a drawing showing other examples of a thin portion.

### DESCRIPTION OF EMBODIMENTS

An example of an embodiment is described in detail below with reference to the drawings. The drawings referred to in the embodiment are schematically drawn, and the dimensional ratio of each of the constituent elements shown in the drawings is appropriately changed. The specific dimensional ratio should be determined in consideration of description below. For the sake of convenience, “upper and lower” is used as a term indicating a direction,, and “upper” represents the sealing body side, and “lower” represents the bottom side of a case body.

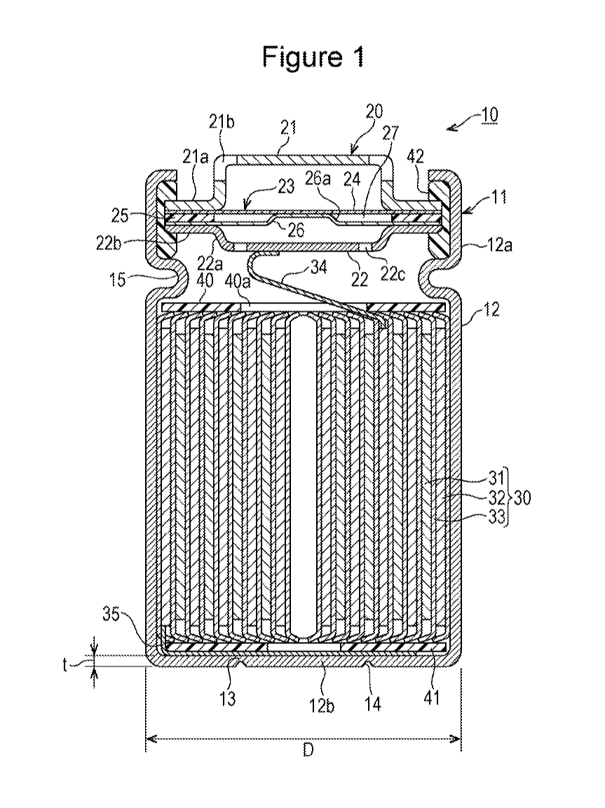

FIG. 1 is a sectional view of a cylindrical nonaqueous electrolyte secondary battery 10 as an example of the embodiment. As shown in FIG. 1, the cylindrical nonaqueous electrolyte secondary battery 10 includes a battery case 11, and an electrode body 30 and an electrolyte which are housed in the battery case 11. Hereinafter, the cylindrical nonaqueous electrolyte secondary battery 10 is simply referred to as the “secondary battery 10”.

The battery case 11 includes a case body 12 serving as a bottomed cylindrical metal-made container, and a sealing body 20 which closes an opening provided at an end (the upper end in FIG. 1) of the case body 12. The inside of the battery case 11 is sealed with the case body 12 and the sealing body 20.

The case body 12 has a projection 15 formed by pushing out an end-side portion (the upper-side portion in FIG. 1) of a cylindrical portion 12a from the outer side to the inner side over the entire periphery. The sealing body 20 is placed on the upper surface of the projection 15 in the case body 12.

The case body 12 is formed in a cylindrical shape having a bottom portion by a pressing process including drawing of a plate of a metal (metal plate) containing iron as a main component. For example, the case body 12 is formed by pressing into a bottomed-cylindrical shape using a nickel-plated steel sheet produced by plating a steel sheet with nickel. The case body 12 may be formed by using a simple steel sheet without nickel plating.

In addition, a thin portion 13 is formed in a bottom plate 12b as the bottom portion of the case body 12. The bottom plate 12b and the sealing body 20 are described later.

The electrode body 30 has a wound-type structure formed by winding a positive electrode 31 and a negative electrode 32 with a separator 33 interposed therebetween. Specifically, the electrode body 30 is formed by spirally winding the positive electrode 31 and the negative electrode 32 with the separator 33 interposed between the positive electrode 31 and the negative electrode 32.

A positive electrode lead 34 and a negative electrode lead 35 are attached to the positive electrode 31 and the negative electrode 32, respectively. The secondary battery 10 includes an upper insulating plate 40 disposed between the electrode body 30 and the sealing body 20 and, in more detail, between the electrode body 30 and the projection 15. Also, the secondary battery 10 includes a lower insulating plate 41 disposed between the electrode body 30 and the bottom plate 12b of the case body 12.

In the example shown in FIG. 1, the positive electrode lead 34 passes through a through hole 40a of the upper insulating plate 40 and extends to the sealing body 20 side, and the negative electrode lead 35 passes outside the lower insulating plate 41 and extends to the bottom plate 12b side of the case body 12.

The secondary battery 10 has a volume energy density of, for example, 650 Wh/L or more. A battery having such a high energy density has a large volume change of the electrode body 30 during charging and discharging. The secondary battery 10 uses a lithium transition metal oxide as a positive electrode active material, a material which can occlude and release lithium ions as a negative electrode active material, and a nonaqueous electrolyte as the electrolyte.

### [Positive Electrode]

The positive electrode 31 includes a positive electrode current collector and positive electrode mixture layers formed on the positive electrode current collector. A foil of a metal stable within the potential range of the positive electrode 31, for example, an aluminum foil or a film having the metal provided in a surface layer, can be used as the positive electrode current collector. The positive electrode mixture layer contains the positive electrode active material. The positive electrode mixture layer preferably contains a conductive material and a binder in addition to the positive electrode active material. The positive electrode 31 can be formed by applying a positive electrode mixture slurry, which contains the positive electrode active material and the binder, on both surfaces of the positive electrode current collector, drying the coating films, and then rolling the coating films to form the positive electrode mixture layers on both surfaces of the current collector.

The lithium transition metal oxide used as the positive electrode active material preferably a Ni content of 80 mol % or more relative to the total amount of metal elements excluding Li. Preferred examples of the lithium transition metal oxide include composite oxides represented by the general formula, LiₐNiₓM₁₋ₓO₂ (0.9≦a≦1.2, 0.8≦x<1, and M is at least one element selected from the group consisting of Co, Mn, and Al), in a discharge state or unreacted state. Among the composite oxides, a Ni—Co—Mn-based lithium transition metal oxide is preferred because of excellent output characteristics and regeneration characteristics. A Ni—Co—Al-based lithium transition metal oxide is more preferred because of high capacity and excellent output characteristics. Examples of the metal element M which may be contained include transition metal elements other than nickel (Ni), cobalt (Co), and manganese (Mn), alkali metal elements, alkaline-earth metal elements, Group 12 elements, Group 13 elements other than aluminum (Al), and Group 14 elements.

The conductive material in the positive electrode mixture layers containing the conductive material is used for enhancing the electric conductivity of the positive electrode mixture layers. Examples of the conductive material include carbon materials such as carbon black (CB), acetylene black (AB), Ketjen black, graphite, and the like. These may be used alone or in combination of two or more.

The binder in the positive electrode mixture layer containing the binder is used for maintaining a good contact state between the positive electrode active material and the conductive material and enhancing the bonding property of the positive electrode active material etc. to the surface of the positive electrode current collector. Examples of the binder include fluorine-based resins such as polytetrafluoroethylene (PTFE), polyvinylidene fluoride (PVdF), and the like, polyacrylonitrile (PAN), polyimide resins, acrylic resins, polyolefin resins, and the like. Also, each of the resins may be used in combination with carboxymethyl cellulose (CMC) or its salt (CMC-Na, CMC-K, CMC-NH₄, or the like, or a partially neutralized salt), polyethylene oxide (PEO), or the like. These may be used alone or in combination of two or more.

### [Negative Electrode]

The negative electrode 32 includes a negative electrode current collector and negative electrode mixture layers formed on the negative electrode current collector. A foil of a metal stable within the potential range of the negative electrode 32, for example, a copper foil or a film having the metal provided in a surface layer, can be used as the negative electrode current collector. The negative electrode mixture layers contain the negative electrode active material. The negative electrode mixture layers preferably contain a binder in addition to the negative electrode active material. The negative electrode 32 can be formed by applying a negative electrode mixture slurry, which contains the negative electrode active material and the binder, on both surfaces of the negative electrode current collector, drying the coating films, and then rolling the coating films to form the negative electrode mixture layers on both surfaces of the current collector.

A material in which lithium ions can be inserted and desorbed is used as the negative electrode active material. Specifically the negative electrode active material contains a silicon compound which is a compound containing silicon (Si). The negative electrode active material preferably contains a compound containing Si and a carbon material such as graphite or the lie. Since Si can occlude more lithium ions than a carbon material such as graphite or the like, the use as the negative electrode active material permits an attempt to increase the capacity of a battery.

A preferred silicon compound is a silicon oxide represented by SiOₓ (0.5≦x≦1.5). The silicon compound preferably contains particles having surfaces coated with a carbon material.

In view of an attempt to effectively increase the capacity of the battery, the content of the silicon compound in the negative electrode active material is preferably 4% by mass or more relative to the total mass of the negative electrode active material.

Like in the positive electrode 31, examples of the binder which can be used in the negative electrode mixture layers containing the binder include fluorine-based resins, PAN, polyimide resins, acrylic resins, polyolefin resins, and the like. When the negative electrode mixture slurry is prepared by using an aqueous solvent, it is preferred to use styrene-butadiene rubber (SBR), CMC or its salt, polyacrylic acid (PAA) or its salt (PAA-Na, PAA-K, or the like, or a partially neutralized salt), polyvinyl alcohol (PVA), or the like.

### [Separator]

A porous sheet having ion permeability and insulation is used as the separator 33. Examples of the porous sheet include a microporous thin film, a woven fabric, a nonwoven fabric, and the like. The material of the separator 33 is preferably an olefin resin such as polyethylene, polypropylene, or the like, or cellulose. The separator 33 may be a laminate including a cellulose fiber layer and a thermoplastic resin fiber layer of an olefin resin or the like.

In view of suppressing deterioration of the separator 33 due to the heat generated from the positive electrode 31 during discharge under a high-temperature condition, a heat resistant layer is preferably formed on the surface of the separator 33 which faces the positive electrode 31. The heat resistant layer is composed of, for example, a resin having excellent heat resistance, such as engineer plastic or the like, or an inorganic compound such as ceramic or the like. Examples of the resin constituting the heat resistant layer include polyamide resins such as aliphatic polyamide, aromatic polyamide (aramid), and the like, polyimide resins such as polyamide-imide, polyimide, and the like. Examples of the inorganic compound include metal oxides, metal hydroxides, and the like. In particular, alumina, titania, boehmite are preferred, and alumina and boehmite are more preferred. The heat resistant layer may use two or more types of inorganic particles. When micro-short-circuit occurs, heat is generated by the flow of short-circuit current, but the heat resistance of the separator 33 is improved by proving the heat resistant layer, and thus melting of the separator 33 due to the heat can be reduced.

[Electrolyte]

The electrolyte is a nonaqueous electrolyte containing, for example, a nonaqueous solvent and an electrolyte salt dissolved in the nonaqueous solvent. The nonaqueous electrolyte is not limited to a nonaqueous electrolytic solution which is a liquid electrolyte and may be a solid electrolyte using a gel-like polymer or the like.

For example, chain carbonate, cyclic carbonate, or the like can be used as the nonaqueous solvent. Examples of the chain carbonate include diethyl carbonate (DEC), methylethyl carbonate (MEC), dimethyl carbonate (DMC), and the like. Examples of the cyclic carbonate include propylene carbonate (PC), ethylene carbonate (EC), vinylene carbonate (VC), and the like. In particular, a mixed solvent of chain carbonate and cyclic carbonate is preferably used as the nonaqueous solvent having low viscosity, low melting point, and high lithium ion conductivity. Also, fluorinated cyclic carbonate such as fluoroethylene carbonate (FEC) or the like can be used.

For the purpose of improving output, a compound containing ester such as methyl acetate, ethyl acetate, propyl acetate, methyl propionate, ethyl propionate, γ-butyrolactone, or the like can be added to the solvent. Also, fluorinated chain carbonate or fluorinated chain carboxylate such as methyl fluoropropionate (FMP) or the like can be used.

For the purpose of improving cycle properties, a compound containing a sulfone group such as propanesultone or the like, or a compound containing ether such as 1,2-dimethoxyethane, 1,2-diethoxyethane, tetrahydrofuran, 1,3-dioxane, 1,4-dioxane, 2-methyltetrahydrofuran, or the like can be added to the solvent.

In addition, a compound containing nitrile such as butyronitrile, valeronitrile, n-heptanenitrile, succinonitrile, glutaronitrile, adiponitrile, pimelonitrile, 1,2,3-propanetricarbonitrile, 1,3,5-pentanetricarbonitrile, or the like, a compound containing amide such as dimethylformamide or the like, or the like can be added to the solvent. A solvent whose hydrogen atoms are partially substituted by fluorine atoms can also be used.

The electrolyte salt dissolved in the nonaqueous solvent is preferably a lithium salt. Examples of the lithium salt include LiBF₄, LiClO₄, LiPF₆, LiAsF₆, LiSbF₆, LiAlCl₄, LiSCN, LiCF₃SO₃, LiC(C₂F₅SO₂), LiCF₃CO₂, Li(P(C₂O₄)F₄), Li(P(C₂O₄)F₂), LiPF₆₋ₓ(CₙF₂ₙ₊₁)ₓ (1<x<6, n is 1 or 2), LiB₁₀Cl₁₀, LiCl, LiBr, LiI, chloroborane lithium, lithium lower aliphatic carboxylates, borate salts such as Li₂B₄O₇, Li(B(C₂O₄)₂) [lithium-bisoxalate borate (LiBOB)], Li(B(C₂O₄)F₂), and the like, imide salts such as LiN(FSO₂)₂, LiN(C₁F₂ₗ₊₁SO₂) (CₘF₂ₘ₊₁SO₂) (l and m are each an integer of 1 or more), and the like. The lithium salts may be used alone or as a mixture of a plurality of salts. Among these, at least a fluorine-containing lithium salt is preferably used from the viewpoint of ion conductivity, electrochemical stability, etc., and for example, LiPF₆ is preferably used. The concentration of the lithium salt is preferably 0.8 mol to 1.8 mol per L of the nonaqueous solvent.

### [Bottom Plate Of Case Body]

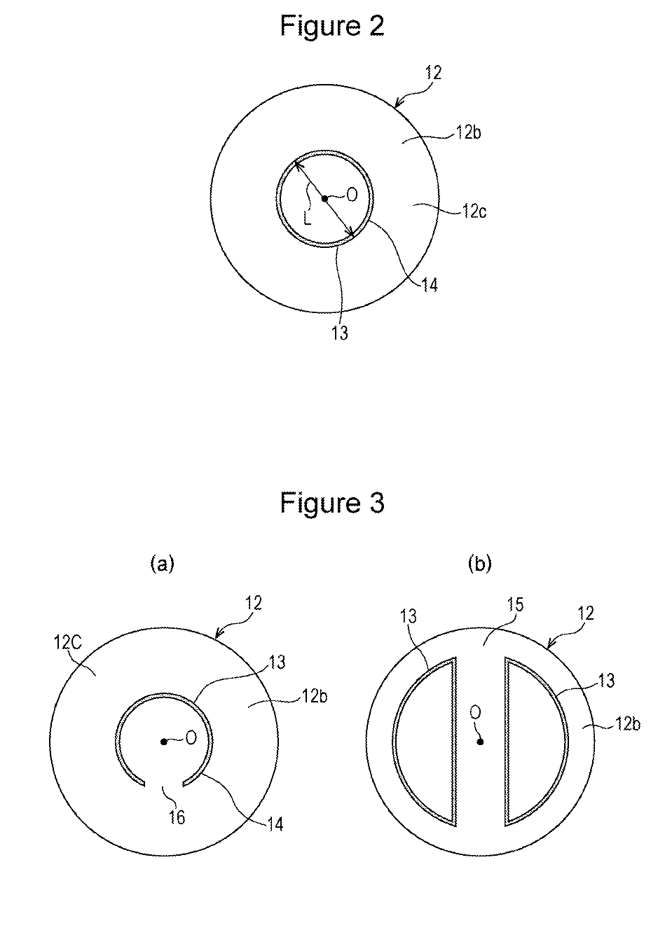

FIG. 2 is a drawing as viewed from the lower side in FIG. 1. The bottom plate 12b of the case body 12 has a thin portion 13 having a shape which forms at least a portion of a ring. FIG. 2 shows the thin portion 13 by sand-like dots. Specifically, the thin portion 13 is formed over the entire periphery of a circle with the center O of the bottom plate 12b at the center. The thin portion 13 is formed by forming an engraved portion 14 including a circular ring recess in a portion corresponding to the thin portion 13 in the lower surface of the bottom plate 12b. The bottom plate 12b includes the thin portion 13 and a portion deviating from the thin portion 13, that is, a body portion 12c other than the thin portion 13, and the thin portion 13 has a smaller thickness than that of the body portion 12c. The thin portion 13 is provided so as to be broken for discharging internal gas to the outside and securing excellent safety when the gas pressure in the battery case 11 is increased.

Also, the thickness t of the body portion 12c of the bottom plate 12b is 0.25 mm<t<0.35 mm.

In addition, the diameter L (FIG. 2) of a portion with the minimum thickness in the thin portion 13 is preferably regulated to satisfy the relation 0.4<L/D<0.7 to the outer diameter D (FIG. 1) of the cylindrical portion 12a constituting the case body 12. With L/D smaller than 0.4, even when the gas pressure in the battery case 11 is increased, the thin portion 13 is hardly broken, and the mechanism of discharging the gas in the battery to the outside cannot be easily secured. While with L/D larger than 0.7, the battery case 11 serving as a case may be deformed.

FIG. 3 shows two other examples of the thin portion 13. In another example of the thin portion 13 shown in FIG. 3(a), the thin portion 13 is formed only in a portion of the circle with the center O of the bottom plate 12b as a center. That is, the thin portion 13 is formed in a C-shaped circular arc. Therefore, the inner peripheral side and the outer peripheral side of the thin portion 13 are connected to each other through a connecting portion 16 having a large thickness. Like in the thin portion shown in FIG. 2, when the internal gas pressure is increased, the thin portion 13 shown in FIG. 3(a) is broken to discharge the gas in the battery case 11 to the outside.

In another example of the thin portion 13 shown in FIG. 3(b), two thin portions 13 are formed on both sides with the center O of the bottom plate 12b therebetween. Each of the thin portions 13 has a ring shape including a circular arc and a straight line connecting both ends of the circular arc. The two thin portions 13 have symmetrical shapes with respect to the center O. The shape of the thin portion 13 is not limited to the shapes shown in FIG. 2 and FIG. 3. For example, a ring partially or entirely formed by the thin portion 13 is not limited to a circular ring and may be a polygonal shape such as a rectangular shape or the like.

### [Sealing Body]

Returning to FIG. 1, the sealing body 20 is mounted on the opening of the case body 12 through a gasket 42, thereby securing inside sealability of the battery case 11. The projection 15 supports the sealing body 20 through the gasket 42.

The sealing body 20 includes a cap 21 serving as a top plate, a filter 22 serving as a bottom plate, and a current cutoff mechanism (CID mechanism) 23. The current cutoff mechanism 23 includes an upper valve body 24, an insulating member 25, and a lower valve body 26. The current cutoff mechanism 23 is disposed between the cap 21 and the filter 22 to form a current path which electrically connects the upper valve body 24 and the lower valve body 26. Further, when the gas pressure in the battery case 11 is increased, the current cutoff mechanism 23 cuts off the current path as described below.

Each of the cap 21, the filter 22, the upper valve body 24, and the lower valve body 26 is made of a metal. The cap 21 has a cylindrical shape in which the upper end is closed, an outward flange 21a is formed over the entire periphery of the lower end. In addition, a cap opening 21b is formed in the upper end portion of the cap 21.

The filter 22 has a cylindrical portion 22a having a taper shape inclined from the axial direction and has a shape with a closed lower end. The filter 22 has an outward flange 22b formed over the entire periphery of the upper end. Also, a filter opening 22c is formed at the lower end portion of the filter 22.

The outer peripheral portions of the upper valve body 24, the insulating member 25, and the lower valve body 26 are held between the flanges 21a and 22b of the cap 21 and the filter 22. The upper valve body 24 is formed in a disk shape. Also, the lower valve body 26 is formed in a disk shape and disposed below the upper valve body 24. A current cutoff valve 26a is formed to project upwardly in a central portion of the lower valve body 26 and is joined by welding to the central portion of the lower surface of the upper valve body 24. The upper surface of the current cutoff valve 26a is a flat surface. In each of the upper valve body 24 and the lower valve body 26, a thin portion (not shown) is formed in a portion outwardly deviating from the joint portion of the current cutoff valve 26a. The thin portion of each of the valve bodies 24 and 26 has the same shape as shown in FIG. 2 or FIG. 3(a). The insulating member 25 is formed in a circular ring shapes and is held between the outer peripheral portions of the upper valve body 24 and the lower valve body 26. Thus, the cap 21 is electrically connected to the filter 22 through the current cutoff mechanism 23.

The positive electrode lead 34 is connected by welding to the lower surface of the filter 22. Therefore, the cap 21 is connected to the positive electrode 31 to serve as a positive electrode terminal. On the other hand, the negative electrode lead 35 is connected by welding to the inner surface of the bottom plate 12b of the case body 12. Therefore, the case body 12 is connected to the negative electrode 32 serve as a negative electrode terminal.

The upper valve body 24 and the lower valve body 26 seal a space below the filter 22 from the outside of the battery case 11. In the upper valve body 24 and the lower valve body 26, when the internal gas pressure is increased by the heat generated due to internal short circuit, the thin portions of the upper valve body 24 and the lower valve body 26 are broken. Further, a valve hole (not shown) is formed in each of the upper valve body 24 and the lower valve body 26. Thus, the gas in the battery case 11 is discharged. Therefore, the current cutoff mechanism 23 also has the function as a safety valve which discharges high-pressure gas.

Also, after the thin portion of the lower valve body 26 is broken, the gas pressure in the space 27 formed between the upper valve body 24 and the lower valve body 26 is increased before the thin portion of the upper valve body 24 is broken, thereby separating between the upper valve body 24 and the lower valve body 26 at the joint portion of the current cutoff valve 26a. Therefore, the current path which electrically connects the upper valve body 24 and the lower valve body 26 is cut off, and the current path which electrically connects the positive electrode 31 and the cap 21 is also cut off. As a result, excellent safety can be secured.

Also, when the gas pressure in the space 27 between the upper valve body 24 and the lower valve body 26 is equal to or higher than a predetermined cutoff pressure, the current path which connects the upper valve body 24 and the lower valve body 26 is cut off by the current cutoff mechanism 23. The cutoff pressure is preferably 12 kgf/cm² or more and 14 kgf/cm² or less. When the cutoff pressure is lower than 12 kgf/cm², the current cutoff valve 26a is easily operated, while when the cutoff pressure is higher than 14 kgf/cm², the current cutoff valve 26a undesirably hardly functions as a cutoff valve even with an increase in internal pressure of the battery.

### [Insulating Plate]

The upper insulating plate 40 is provided between the electrode body 30 and the projection 15 as described above. The upper surface of the outer peripheral portion of the upper insulating plate 40 faces the projection 15, and thus movement of the upper insulating plate 40 toward the sealing body 20 side is inhibited.

The upper insulating plate 40 may include a fiber-reinforced phenol resin as a main component. When the fiber-reinforced phenol resin is used as a main component, an insulating plate having high strength and high heat resistance can be produced. In addition, the upper insulating plate 40 may contain, for example, a reinforcing material other than fibers, such as silica, clay, mica, or the like, or a resin (for example, an epoxy resin, a polyimide resin, or the like) having high heat resistance other than the phenol resin. Examples of the fibers contained in the upper insulating plate 40 include boron fibers, aramid fibers, glass fibers, and the like. The glass fibers are particularly preferred, and a preferred example of the constituent material is a glass fiber-reinforced phenol resin (glass phenol).

The through hole 40a of the upper insulating plate 40 is provided for passing the positive electrode lead 34 and passing the gas generated in power generation elements including the electrode body 30. The same insulating plate as the upper insulating plate 40 can be used as the lower insulating plate 41.

### [Effect of Present Disclosure]

As described above, the thickness t of the bottom plate 12b of the case body 12 constituting the battery case 11 is 0.25 mm<t<0.35 mm, and the thin portion 13 is formed in the bottom plate 12b. Therefore, when the gas pressure in the battery case 11 tends to be increased, the bottom plate 12b is easily broken outward, and thus the inner volume can be increased. Thus, when the secondary battery 10 is used for a long time or when used under a high-temperature condition, it is possible to suppress increases in the pressure applied to the electrode surfaces of the positive electrode 31 and the negative electrode 32 and the gas pressure in the secondary battery 10. Therefore, when the negative electrode active material contains a silicon compound, the cycle characteristic such as a retention rate of the battery capacity in a predetermined charge-discharge cycle can be improved. Also, during long-term or high-temperature storage, malfunction of the current cutoff mechanism 23 can be suppressed. As a result, an attempt can be made to improve the lifetime of the secondary battery 10. Also, the thickness t of the bottom plate 12b is regulated to be 0.25 mm<t, and thus the thickness of the cylindrical portion 12a of the case body 12 is larger than about 0.25 mm. Therefore, the strength of the cylindrical portion 12a can be secured, and thus when the case body 12 is produced by pressing a metal plate into a cylindrical shape, a thickness equal to or larger than the limit thickness in producing the cylindrical portion 12a can be secured.

### EXPERIMENTAL EXAMPLES

The present disclosure is described in further detail below by experimental examples, but the present disclosure is not limited to these experimental examples.

### EXPERIMENTAL EXAMPLE 1

### Experimental Example 1-1

[Formation of Positive Electrode]

First, 100 parts by mass of lithium nickel cobalt aluminum composite oxide represented by LiNi_{0.91}CO_{0.06}Al_{0.03}O₂ and used as a positive electrode active material, 1 part by mass of acetylene black (AB), and 1 part by mass of polyvinylidene fluoride (PVdF) were mixed, and an appropriate amount of N-methyl-2-pyrrolidone (NMP) was further added to the resultant mixture to prepare a positive electrode mixture slurry. Next, the positive electrode mixture slurry was applied on both surfaces of a positive electrode current collector composed of an aluminum foil havinq a thickness of 14 μm, and dried. The resultant positive electrode current collector was cut into a predetermined electrode size and rolled by using a roller so that the positive electrode composite density was 3.6 g/cc, thereby forming a positive electrode 31 including positive electrode mixture layers formed on both surfaces of the positive electrode current collector.

[Formation of Negative Electrode]

First, 93 parts by mass of graphite powder used as a negative electrode active material, 7 parts by mass of silicon oxide (SiO) particles with the surfaces coated with carbon, 1 part by mass of carboxymethyl cellulose (CMC), and 1 part by mass of styrene-butadiene rubber (SBR) were mixed, and an appropriate amount of water was further added to the resultant mixture to prepare a negative electrode mixture slurry. Next, the negative electrode mixture slurry was applied on both surfaces of a negative electrode current collector composed of a copper foil haying a thickness of 7 μm, and dried. The resultant negative electrode current collector was cut into a predetermined electrode size and rolled by using a roller so that the composite density was 1.65 g/cc, thereby forming a negative electrode 32 including negative electrode mixture layers formed on both surfaces of the negative electrode current collector. The content of silicon oxide (SiO) in the negative electrode active material was 7% by mass.

[Preparation of Nonaqueous Electrolytic Solution]

Ethylene carbonate (EC), dimethyl carbonate (DMC), and methylethyl carbonate (MEC) were mixed at a volume ratio of 20:75:5. Next, LiPF₆ was dissolved in the resultant mixed solvent so that the concentration was 1.4 mol/L to prepare a nonaqueous electrolytic solution.

[Formation of Battery]

A positive electrode lead 34 made of aluminum was attached to the positive electrode 31, and a negative electrode lead 35 made of nickel was attached to the negative electrode 32. The positive electrode 31 and the negative electrode 32 were spirally wound with a separator 33 disposed therebetween to form a wound-type electrode body 30. The separator 33 used was formed by forming a heat resistant layer containing polyamide and alumina filler dispersed therein on one of the surfaces of a polyethylene microporous film. The electrode body 30 was housed in a case body 12 having an outer diameter of 18.2 mm and a height of 65 mm, and the nonaqueous electrolytic solution was injected into the case body 12. Then, an opening of the case body 12 was sealed with a gasket 42 and a sealing body 20, thereby forming a secondary battery 10 of 18650 type having a volume energy density of 760 Wh/L. The secondary battery 10 has a structure shown in FIG. 1 and FIG. 2.

Also, the thickness t of the bottom plate 12b of the case body 12 was adjusted to be 0.3 mm, and a thin portion 13 was formed by forming an engraved portion 14 in the bottom plate 12b. In addition, the diameter L of a portion having the minimum thickness in the thin portion 13 and the outer diameter D of the cylindrical portion 12a constituting the case body 12 were regulated to satisfy the relation 0.4<L/D<0.7, more specifically a L/D of 0.5.

### Experimental Example 1-2

The thickness t of the bottom plate of the case body 12 was 0.4 mm. The other configurations were the same as in Experimental Example 1-1.

Each of the batteries of Experimental Examples 1-1 and 1-2 was evaluated with respect to initial bottom bulging and charge-discharge cycle characteristics at 0.5 It to 1.0 It. The results of evaluation are shown in Table 1. The initial bottom bulging of each of the batteries was evaluated by charging for a predetermined time with a predetermined charging current and then discharging for a predetermined time at a predetermined discharging current. The cycle was regarded as one cycle and performed one time.

Then, the total length of the battery after one cycle was measured. The initial total length of the battery previously measured before the charge-discharge cycle was subtracted from the measured total length, and the obtained value was determined as an amount of initial bottom bulging.

[Measurement of Capacity Retention Rate of Charge-Discharge Cycle]

Each of the batteries formed as described above in Experimental Examples 1-1 and 1-2 was charged with a constant current of 0.5 It (=1700 mA) in a constant-temperature bath of 25° C. until the battery voltage reached 4.2 V. After the battery voltage had reached 4.2 V, the battery was further charged with a constant voltage of 4.2 V until the current value was 0.02 It (=68 mA). Then, the battery was discharged with a constant current of 1 It (=3400 pA) until the battery voltage was 2.5 V. This charge-discharge cycle was regarded as a first charge-discharge cycle, and in this cycle, the discharge capacity was measured as an initial capacity.

Next, the charge-discharge cycle was repeated for each of the batteries subjected to measurement of the initial capacity, and the discharge capacity at the 400th cycle was measured. The capacity retention rate after 400 cycles was calculated by a calculation formula (1). The obtained results are summarized in Table 2.

Capacity retention rate (%)=(discharge capacity after 400 cycles/initial capacity)×100 . . . (1)

TABLE 1

| | Ni in transition | | | | | |
|---|---|---|---|---|---|---|
| | metal of | Content of | Thickness | | | |
| | positive | SiOₓ in | of | Initial | | Capacity |
| | electrode | negative | bottom | bottom | Engraved | retention |
| | mol % | electrode | plate | bulging | portion | rate |
| Experimental | 91% | 7% | 0.3 mm | 0.073 mm | Yes | 61% |
| Example 1-1 | | | | | | at 400cy |
| Experimental | 91% | 7% | 0.4 mm | 0.000 mm | Yes | 44% |
| Example 1-2 | | | | | | At 400cy |

Table 1 indicates that when the thickness t of the bottom plate 12b is 0.3 mm and the thin portion 13 is formed (engraving), initial bottom bulging can be generated (refer to Experimental Example 1-1). Also, in Experimental Example 1-1, the good charge-discharge cycle characteristics could be obtained (capacity retention rate of 61% after 400 cycles). On the other hand, when the thickness t of the bottom plate 12b was 0.4 mm, initial bottom bulging did not occur (refer to Experimental Example 1-2). Also, in Experimental Example 1-2, the charge-discharge cycle characteristics were decreased (capacity retention rate of 44% after 400 cycles).

### EXPERIMENTAL EXAMPLE 2

### Experimental Example 2-1

In Experimental Example 2, Experimental Examples 2-1 to 2-11 were performed. The configuration of Experimental Example 2-1 was the same as in Experimental Example 1-1. In Experimental Example 2, a “high-temperature storage test” described below was performed as an evaluation item. Table 2 shows the number of batteries producing cutoff of the current. Also, the cutoff pressure of the current cutoff mechanism 23 was determined.

[Measurement of High-Temperature Storage Test]

Each of the batteries was charged with a constant current of 0.3 It (=1020 mA) in a constant-temperature bath of 25° C. until the battery voltage reached 4.2 V. After the battery voltage had reached 4.2 V, the battery was charged with a constant voltage of 4.2 V until the current value was 0.02 It (=6:8 mA). Then, the battery was stored in a constant-temperature bath of 80° C. for 3 days, and whether or not current cutoff occurred in the current cutoff mechanism 23 was evaluated as a “storage characteristic”. The number of the batteries evaluated was 3.

### Experimental Example 2-2

In Experimental Example 2-2, the content of Ni in transition metals of the positive electrode active material was 88 mol %. The other configurations were the same as in Experimental Example 1-1.

### Experimental Example 2-3

In Experimental Example 2-3, the current cutoff pressure was 12.0 kgf/cm². The other configurations were the same as in Experimental Example 1-1.

### Experimental Example 2-4

In Experimental Example 2-4, the current cutoff pressure was 12.5 kgf/cm². The other configurations were the same as in Experimental Example 1-1.

### Experimental Example 2-5

In Experimental Example 2-5, the current cutoff pressure was 13.5 kgf/cm². The other configurations were the same as in Experimental Example 1-1.

### Experimental Example 2-6

In Experimental Example 2-6, the current cutoff pressure was 14.0 kgf/cm². The other configurations were the same as in Experimental Example 1-1.

### Experimental Example 2-7

In Experimental Example 2-1, the thickness t of the bottom plate 12b was 0.28 mm. The other configurations were the same as in Experimental Example 2-1.

### Experimental Example 2-8

In Experimental Example 2-8,the thickness t of the bottom plate 12b was 0.32 mm. The other configurations were the same as in Experimental Example 2-1.

### Experimental Example 2-9

In Experimental Example 2-9, the ratio of SiO in the negative electrode active material was 4% by mass. The other configurations were the same as in Experimental Example 2-1.

### Experimental Example 2-10

In Experimental Example 2-10, the thickness t of the bottom plate 12b was 0.4 mm. The other configurations were the same as in Experimental Example 2-1.

### Experimental Example 2-11

In Experimental Example 2-11, the thickness t of the bottom plate 12b was 0.3 mm which was the same as in Experimental Example 2-1, but an engraved, portion was not formed in the bottom plate 12b and thus the thin portion 13 was not formed. The other, configurations were the same as in Experimental Example 2-1. The results of evaluation in Experimental Example 2-1 to Experimental Example 2-11 are shown in Table 2.

TABLE 2

| | Ni in | | | | | | |
|---|---|---|---|---|---|---|---|
| | transition | Content | | | | | |
| | metal of | of SiOₓ | | | | | |
| | positive | in | Thickness | Initial | | Cutoff | |
| | electrode | negative | of bottom | bottom | Engraved | pressure | Storage |
| | mol % | electrode | plate | bulging | portion | (kgf/cm²) | characteristic |
| Experimental | 91% | 7% | 0.3 mm | 0.073 mm | Yes | 13.0 | 0 |
| Example 2-1 | | | | | | | |
| Experimental | 88% | 7% | 0.3 mm | 0.072 mm | Yes | 13.0 | 0 |
| Example 2-2 | | | | | | | |
| Experimental | 91% | 7% | 0.3 mm | 0.077 mm | Yes | 12.0 | 1 |
| Example 2-3 | | | | | | | |
| Experimental | 91% | 7% | 0.3 mm | 0.075 mm | Yes | 12.5 | 0 |
| Example 2-4 | | | | | | | |
| Experimental | 91% | 7% | 0.3 mm | 0.078 mm | Yes | 13.5 | 0 |
| Example 2-5 | | | | | | | |
| Experimental | 91% | 7% | 0.3 mm | 0.076 mm | Yes | 14.0 | 0 |
| Example 2-6 | | | | | | | |
| Experimental | 91% | 7% | 0.28 mm | 0.079 mm | Yes | 13.0 | 0 |
| Example 2-7 | | | | | | | |
| Experimental | 91% | 7% | 0.32 mm | 0.065 mm | Yes | 13.0 | 0 |
| Example 2-8 | | | | | | | |
| Experimental | 91% | 4% | 0.3 mm | 0.013 mm | Yes | 13.0 | 1 |
| Example 2-9 | | | | | | | |
| Experimental | 91% | 7% | 0.4 mm | 0.000 mm | Yes | 13.0 | 3 |
| Example 2-10 | | | | | | | |
| Experimental | 91% | 7% | 0.3 mm | 0.000 mm | No | 13.0 | 3 |
| Example 2-11 | | | | | | | |

Table 2 indicates that in Experimental Example 2-1 to Experimental Example 2-9 in which the thickness t of the bottom plate 12b was regulated to be 0.25 mm<t<0.35 mm and the thin portion 13 (engraved portion) was formed, initial bottom bulging could be generated. Also, in Experimental Example 2-1 to Experimental Example 2-9, the number of batteries causing current cutoff was as small as 0 to 1, and a good result was exhibited. On the other hand, in Experimental Example 2-10 in which the thickness t of the bottom plate 12b was as large as 0.4 mm, initial bottom bulging was not generated, and the number of batteries producing cutoff of the current was 3. Also, in Experimental Example 2-11 in which an engraved portion was not formed in the bottom plate 12b and thus the thin portion was not formed, initial bottom bulging was not generated, and the number of batteries producing cutoff of the current was 3. Therefore, it can be confirmed that even when the thickness t of the bottom plate 12b satisfies 0.25 mm<t<0.35 mm, with the bottom plate 12b not having a thin portion, the effect of the present disclosure cannot be achieved.

### INDUSTRIAL APPLICABILITY

According to the present invention, development can be expected from, for example, drive power supplies for mobile information, terminals of a cellular phone, a notebook-size personal computer, a smartphone, and the like, drive power supplies for high output for an electric vehicle, HEV, and an electric tool, and power storage-related power supplies.

### REFERENCE SIGNS LIST

10 cylindrical nonaqueous electrolyte secondary battery (secondary battery), 11 battery case, 12 case body, 12a cylindrical portion, 12b bottom plate, 12c body portion, 13 thin portion, 14 engraved portion, 15 projection, 16 connecting portion, 20 sealing body, 21 cap, 21a flange, 21b cap opening, 22 filter, 22a cylindrical portion, 22b flange, 22c filter opening, 23 current cutoff mechanism, 24 upper valve body, 25 insulating member, 26 lower valve body, 26a current cutoff valve, 27 space, 30 electrode body, 31 positive electrode, 32 negative electrode, 33 separator, 34 positive electrode lead, 35 negative electrode lead, 40 upper insulating plate, 40a through hole, 41 lower insulating plate, 42 gasket

1. A cylindrical nonaqueous electrolyte secondary battery comprising:
a bottomed cylindrical case body which houses an electrode body; and
a sealing body which seals an opening of the case body,
wherein the electrode body is formed by winding a positive electrode having a positive electrode active material and a negative electrode having a negative electrode active material with a separator interposed between the positive electrode and the negative electrode, and the negative electrode active material contains a compound containing silicon (Si);
the sealing body has a current cutoff mechanism which includes an upper valve body and a lower valve body disposed below the upper valve body to be connected to the upper valve body and in which a current path is formed to electrically connect the electrode body and the upper valve body through the lower valve body, and when the gas pressure in a space formed between the upper valve body and the lower valve body is increased, the upper valve body is separated from the lower valve body to cut off the current path;
a bottom portion of the case body has a thin portion which forms at least a portion of a ring, and the thickness t of a portion deviating from the thin portion of the bottom portion is 0.25 mm<t<0.35 mm.

2. The cylindrical nonaqueous electrolyte secondary battery according to claim 1, wherein the case body is made of a metal containing iron as a main component.

3. The cylindrical nonaqueous electrolyte secondary battery according to claim 1, wherein the content of the compound containing silicon in the negative electrode active material is 4% by mass or more relative to the total mass of the negative electrode active material.

4. The cylindrical nonaqueous electrolyte secondary battery according to claim 1,
wherein the current cutoff mechanism cuts off the current path when the gas pressure in the space between the upper valve body and the lower valve body is equal to or higher than a cutoff pressure; and
the cutoff pressure is 12 kgf/cm² or more and 14 kgf/cm² or less.

5. The cylindrical nonaqueous electrolyte secondary battery according to claim 1, wherein the thin portion is formed in a ring shape or a circular arc shape.

6. The cylindrical nonaqueous electrolyte secondary battery according to claim 5, wherein the diameter L of the thin portion satisfies the relation 0.4<L/D<0.7 to the outer diameter D of a cylindrical portion constituting the case body.
